(19) United States
(12) Patent Application Publication
(10) Pub. No.: US 2019/0102658 A1
(43) Pub. Date: Apr. 4, 2019

(54) HIERARCHICAL IMAGE CLASSIFICATION METHOD AND SYSTEM

(71) Applicant: Institute For Information Industry, Taipei (TW)

(72) Inventors: Sheng-Yuan WANG, New Taipei City (TW); Wen-Shan LIOU, New Taipei City (TW)

(21) Appl. No.: 15/811,242

(22) Filed: Nov. 13, 2017

(30) Foreign Application Priority Data
Oct. 3, 2017 (TW) 106134210

(51) Int. Cl. G06K 9/62; G06N 3/08

(52) U.S. Cl. CPC G06K 9/6282; G06N 3/08; G06K 9/6268; G06K 9/6256

(57) ABSTRACT

A hierarchical image classification method and system are provided. The hierarchical image classification method derives a coarse classification result of an image by analyzing the image according to a coarse classification model, derives at least one fine classification model by inquiring a classification relation table according to the coarse classification result, derives at least one level information by inquiring a level relation table according to the at least one fine classification model, retrieves at least one coarse feature descriptor from the coarse classification model according to the at least one level information, and decides at least one fine classification result according to the at least one fine classification model and the at least one coarse feature descriptor. The hierarchical image classification method may inquire the classification relation table and the level relation table repeatedly to continuously decide other fine classification result(s).

### PRIORITY

This application claims priority to Taiwan Patent Application No. 106134210 filed on Oct. 3, 2017, which is hereby incorporated by reference in its entirety.

### FIELD

The present invention relates to an image classification method and system, and more particularly, the present invention relates to a hierarchical image classification method and system.

### BACKGROUND

In recent years, like other machine learning methods, artificial neural networks (ANNs, which are also referred to as analog neural networks) have been used for resolving various kinds of problems, e.g., machine vision and speech recognition. These artificial neural networks are trained with techniques such as deep learning or computer learning or the like. In the field of image classification, feature classification may be performed on an image by adopting the artificial neural networks that have been trained to identify correct image information.

FIG. 1A shows an image classification architecture in the prior art that is based on a Deep Convolutional Neural Network (DCNN), and the image classification architecture uses a coarse classification model and a plurality of fine classification models to perform coarse and fine classification on the image. Each of the aforesaid classification models (including the coarse classification model and the fine classification models) is a deep convolutional neural network. Depending on the image classification architecture adopted in the prior art, the coarse classification model and the number and types of the fine classification models at the next level corresponding to the coarse classification model are already determined at the initial design stage. Therefore, if the number and types of the fine classification models are not accurate enough and thus need to be updated and adjusted, then it is necessary to re-train the coarse classification model and all the fine classification models, i.e., re-train all the deep convolutional neural networks, which is considerably time-consuming. Moreover, the fine classification models cannot be adjusted adaptively to improve the accuracy of image classification and more detailed information cannot be provided for the image in the prior art.

In order to solve the aforesaid problem, an urgent need exists in the art to provide a mechanism that is capable of efficiently adjusting or updating image classification models and provide a technique that does not need to re-train all the deep convolutional neural networks, thereby saving the time required for re-training all the models and improving the accuracy of image classification.

### SUMMARY

The disclosure includes a hierarchical image classification method adapted for at least one electronic computing device. The hierarchical image classification method in one example comprises: (a) deriving a coarse classification result of an image by analyzing the image according to a coarse classification model; (b) deriving at least one fine classification model associated with the coarse classification result by inquiring a classification relation table according to the coarse classification result; (c) deriving at least one level information of the coarse classification model associated with the at least one fine classification model respectively by inquiring a level relation table according to the at least one fine classification model; (d) retrieving at least one coarse feature descriptor corresponding to the at least one level information respectively from the coarse classification model; and (e) deciding at least one fine classification result according to the at least one fine classification model and the at least one coarse feature descriptor.

The hierarchical image classification method may further comprise the following steps of: (f) deriving at least one fine classification model associated with each of the at least one fine classification result by inquiring the classification relation table according to the fine classification result; and (g) repeating the steps (c) to (f) until the number of the at least one fine classification model derived is unvaried, and then outputting the coarse classification result and the at least one fine classification result.

The disclosure also includes a hierarchical image classification system which comprises a receiving interface and at least one processor. The at least one processor is electrically connected to the receiving interface and is configured to execute a coarse classification module, a classification management module, and a fine classification module. The receiving interface is configured to receive an image. The coarse classification module derives a coarse classification result of the image by analyzing the image according to a coarse classification model. The classification management module derives at least one fine classification model associated with the coarse classification result by inquiring a classification relation table according to the coarse classification result. The classification management module derives at least one level information of the coarse classification model associated with the at least one fine classification model respectively by inquiring a level relation table according to the at least one fine classification model. The coarse classification module retrieves at least one coarse feature descriptor corresponding to the at least one level information respectively from the coarse classification model. The fine classification module decides at least one fine classification result according to the at least one fine classification model and the at least one coarse feature descriptor.

The hierarchical image classification system may further enable the classification management module to derive at least one fine classification model associated with each of the at least one fine classification result by inquiring the classification relation table according to the fine classification result. If the number of the at least one fine classification model derived varies, then the hierarchical image classification system repeats the aforesaid operations to perform finer classification with the at least one fine classification model newly derived. If the number of the at least one fine classification model derived is unvaried, then the classification management module outputs the coarse classification result and the at least one fine classification result.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

Through the following detailed description and attached drawings, the present invention will be understood more fully. However, it shall be appreciated that, the attached drawings are only provided for illustration instead of limiting the present invention, and in the attached drawings:

FIG. 1A is a schematic view illustrating an image classification architecture adopted in the prior art that is based on a deep convolutional neural network;

FIG. 1B is a schematic view illustrating the architecture of a hierarchical image classification technique of the present invention;

FIG. 2 is a flowchart diagram of a hierarchical image classification method according to a first embodiment of the present invention;

FIG. 3A is a block diagram of a hierarchical image classification system based on the convolutional neural network according to a second embodiment of the present invention; and

FIG. 3B to FIG. 3C are schematic views illustrating the establishing and the updating of a classification relation table and a level relation table according to the second embodiment of the present invention.

### DETAILED DESCRIPTION

In the following description, the present invention will be explained with reference to exemplary embodiments thereof. However, these exemplary embodiments are not intended to limit the present invention to any particular examples, embodiments, environment, applications or implementations described in these embodiments. Therefore, description of these exemplary embodiments is only for purpose of illustration rather than to limit the present invention, and the scope claimed in this application shall be governed by the claims.

It shall be appreciated that, in the following embodiments and the attached drawings, elements unrelated to the present invention are omitted from depiction; and dimensional relationships among individual elements in the attached drawings are illustrated only for ease of understanding, but not to limit the actual scale.

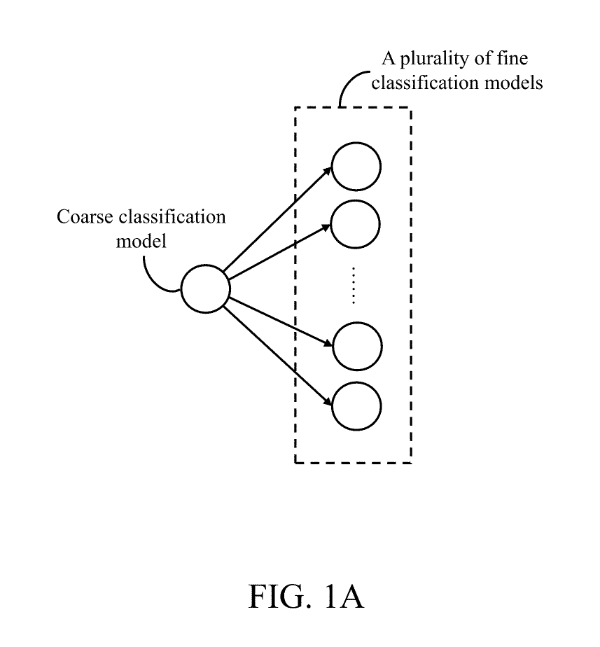

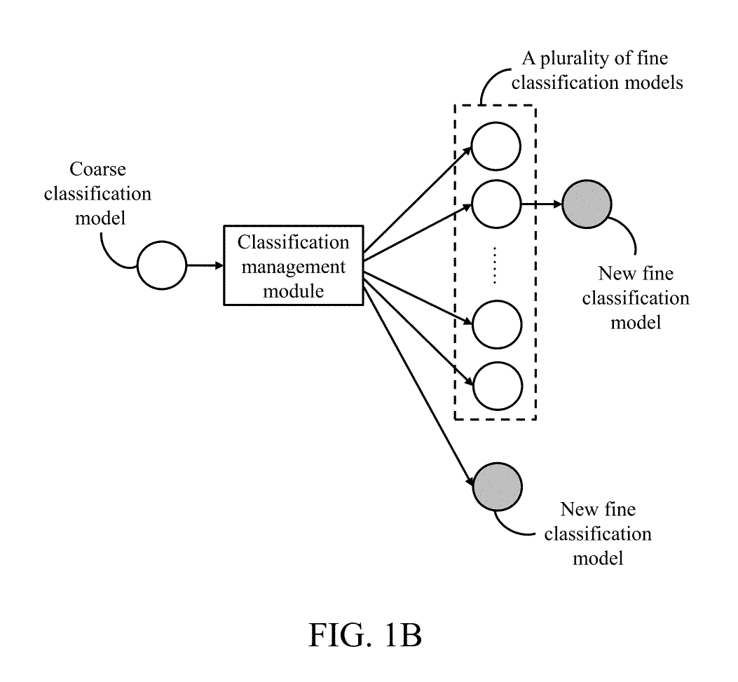

FIG. 1B is a schematic view illustrating the architecture of a hierarchical image classification technique of the present invention. Generally speaking, the image classification technique of the present invention first performs coarse classification on an image by using a coarse classification model, and inquiries (e.g., a classification management module may be implemented to inquire) which fine classification models associated with the coarse classification model are available at the next level according to the coarse classification result, and then further performs fine classification on the image by using the fine classification model derived. The present invention may continuously find fine classification models at the next level to perform finer classification until no fine classification model is available at the next level. By establishing correspondence relationships among classification models at different levels, the present invention can update any fine classification model (i.e., add, delete or adjust any fine classification model) at any time without the need of re-training all the classification models, thereby efficiently improving the accuracy of image classification.

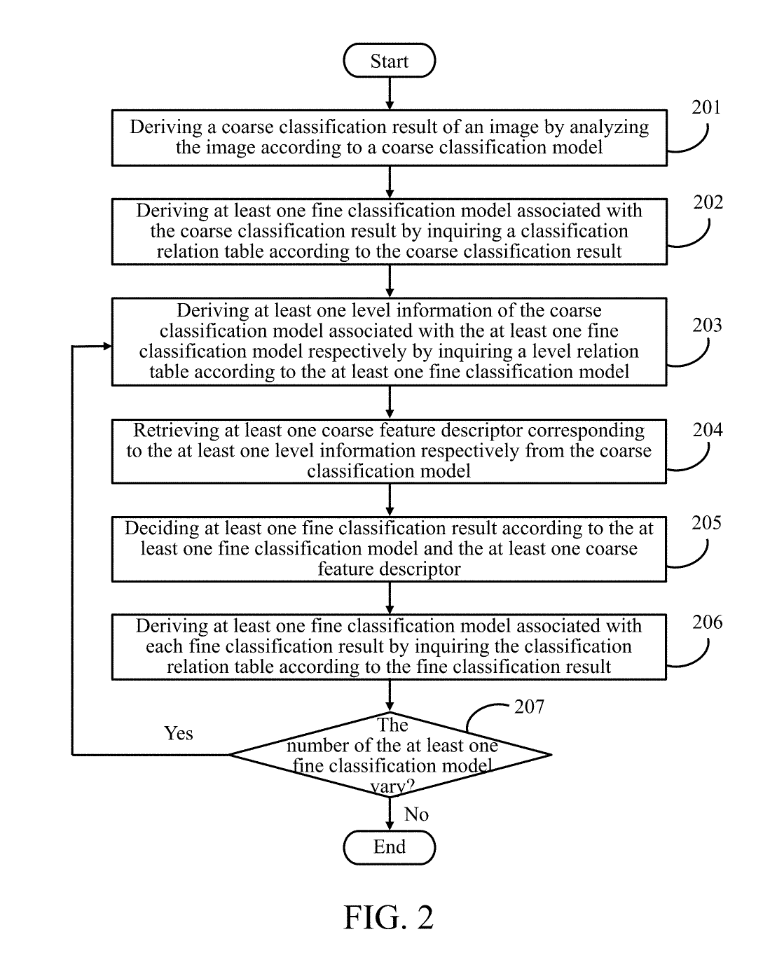

A first embodiment of the present invention is a hierarchical image classification method, and a flowchart diagram thereof is depicted in FIG. 2. The hierarchical image classification method may be executed by at least one electronic computing device (e.g., a computer, a server or other devices having the similar electronic computing capability). The hierarchical image classification method comprises the following steps 201 to 205, and details of each of the steps are described in detail as follows.

Step 201: deriving a coarse classification result of an image by analyzing the image according to a coarse classification model.

Step 202: deriving at least one fine classification model associated with the coarse classification result by inquiring a classification relation table according to the coarse classification result derived in the step 201.

The aforesaid at least one electronic computing device comprises the coarse classification model and a plurality of preset fine classification models, and the preset fine classification models include the at least one fine classification model derived in the aforesaid step 202. In some implementations, the coarse classification model and the preset fine classification models are obtained by training with a deep learning method individually. For example, each of the coarse classification model and the preset fine classification models may be a deep convolutional neural network (DCNN).

In some implementations, the hierarchical image classification method may derive each of the aforesaid preset fine classification models by training with the following step (a) (not shown) or step (b) (not shown).

Step (a): obtaining a preset fine classification model by training the coarse classification model with a fine-tune method or a transfer learning method.

Step (b): obtaining a preset fine classification model by training the coarse classification model with a coarse feature descriptor of a low level information of the coarse classification model. The low level information refers to the first to the third levels of the coarse classification model, and the coarse feature descriptor of the low level information includes information of some simple image features, e.g., features such as edges, corner angles, curves, light spots or the like. As compared to the low level information, the coarse feature descriptor of the high level information (i.e., not the first to the third levels) includes more complicated image features, e.g., features such as shapes and patterns or the like.

The aforesaid classification relation table records relations between the coarse classification model and the preset fine classification models as well as relations among these preset fine classification models. For example, the hierarchical image classification method may establish the classification relation table according to relations among information of the coarse classification model (e.g., relevant information such as the name of the model, members in the model or the like), information of the preset fine classification models (e.g., relevant information such as names of the models, members in the models or the like) and use of the preset fine classification models (e.g., clothes to be worn, vehicles to be driven or the like).

In some implementations, the aforesaid classification relation table may be as shown in Table 1. However, the specific exemplary example shown in Table 1 is not intended to limit the scope of the present invention.

TABLE 1

| Fine | Label | | | | | |
|---|---|---|---|---|---|---|
| classification model | Vehicle | Clothes | Trouser | Flower | Rose | . . . |
| Flower type | | | | ◯ | | |
| Vehicle model | ◯ | | | | | |
| Vehicle brand | ◯ | | | | | |
| Clothes type | | ◯ | | | | |
| Trouser type | | | ◯ | | | |
| Cloth material | | ◯ | ◯ | | | |
| Rose variety | | | | | ◯ | |
| . . . | | | | | | |

Words in fields of Label in Table 1 (i.e., Vehicle, Clothes, Trouser, Flower, Rose or the like) represent the coarse classification result or the fine classification result. In the specific exemplary example shown in Table 1, if the coarse classification result is Vehicle, then the fine classification models associated with Vehicle include Vehicle model and Vehicle brand.

If the coarse classification result is Rose, then the fine classification model associated with Rose is Rose variety.

Step 203: deriving at least one level information of the coarse classification model associated with the at least one fine classification model respectively by inquiring a level relation table according to the at least one fine classification model derived in the step 202.

It shall be appreciated that, the coarse classification model comprises a plurality of levels, and each of the preset fine classification models corresponds to one of the levels. In some implementations, the level relation table records each of the preset fine classification models and a serial number of the level corresponding to the preset fine classification model. Each of the at least one level information derived in the step 203 is the serial number of a certain level.

In some implementations, the aforesaid level relation table may be as shown in Table 2. However, the specific exemplary example shown in Table 2 is not intended to limit the scope of the present invention.

TABLE 2

| | Level information |
|---|---|
| Preset fine | (Serial number of |
| classification model | the level) |
| Flower variety | 10 |
| Vehicle model | 12 |
| Vehicle brand | 7 |
| Clothes type | 11 |
| Trouser type | 11 |
| Cloth material | L |
| Rose variety | L |
| . . . | . . . |

How the hierarchical image classification method determines the level information corresponding to each of the preset fine classification models (i.e., the serial number of the level of the coarse classification model) will be described by taking Table 2 as an example. When training a certain preset fine classification model, the hierarchical image classification method retrieves the coarse feature descriptors of different levels of the coarse classification model for training (e.g., using the coarse feature descriptor of the high level information of the coarse classification model for fine-tuning or transfer learning, or using the coarse feature descriptor of the low level information of the coarse classification model for training), and records the level information (i.e., the serial number of that level) that is used when the highest accuracy is obtained into the level relation table. In the specific exemplary example shown in Table 2, the fine classification model “Vehicle model” corresponds to the 12^{th} level of the coarse classification model, and this means that the hierarchical image classification method obtains the highest accuracy when it previously trains the fine classification model “Vehicle mode” with the coarse feature descriptor of the 12^{th} level of the coarse classification model. As another example, the fine classification model “Cloth material” corresponds to the L^{th} level of the coarse classification model, and this means that the hierarchical image classification method obtains the highest accuracy when it previously trains the fine classification model “Cloth material” with the coarse feature descriptor of the L^{th} level of the coarse classification model, and the L^{th} level (i.e., the low level) is one of the first to the third levels.

Step 204: retrieving at least one coarse feature descriptor corresponding to the at least one level information respectively from the coarse classification model according to the at least one level information derived in the step 203.

Step 205: deciding at least one fine classification result according to the at least one fine classification model and the at least one coarse feature descriptor.

Through the aforesaid steps 201 to 205, the hierarchical image classification method of the first embodiment can determine the coarse classification result (i.e., to which coarse classification the image belongs) and the fine classification result (i.e., to which fine classification(s) the image belongs) of the image.

In some implementations, the hierarchical image classification method may further enable the at least one electronic computing device to execute steps 206 and 207 to obtain a finer classification result, and details of each of the steps are described in detail as follows.

Step 206: deriving at least one fine classification model associated with each of the at least one fine classification result by inquiring the classification relation table according to the fine classification result.

Step 207: determining whether the number of the at least one fine classification model derived (the number of all the fine classification models that have been derived) varies. If the determination result is yes, then the steps 203 to 207 are repeated with each of the fine classification models that are newly derived. If the determination result is no (i.e., the number of the at least one fine classification model derived is unvaried), then the image classification process is ended and the coarse classification result and all the fine classification results are outputted.

During the process of repeating the steps 203 to 207, the hierarchical image classification method continuously inquires the classification relation table to determine whether there is at least one associated fine classification model according to the at least one fine classification result inputted, and continuously performs fine classification to the next level until no finer classification can be performed any more. If at least one associated fine classification model cannot be derived in the step 206, then it means that the total number of the associated fine classification models that have been derived does not increase any more from the past to the present. In this case, it means that this fine classification result is fine enough and no finer classification can be performed any more, so the coarse classification result and all the fine classification results can be outputted at this point.

It shall be appreciated that, in some implementations, the hierarchical image classification method may further execute a step to store the at least one coarse feature descriptor retrieved in the step 204. In these implementations, during the aforesaid process of repeating the steps 203 to 207, the step 204 is omitted and the step 205 is directly executed to decide at least one fine classification result according to the currently used fine classification model and the aforesaid coarse feature descriptor that has been stored if the level information that is the same as the previous level information is derived by inquiring the level relation table in the step 203, and then the steps 206 and 207 are executed.

For ease of understanding, the aforesaid steps will be detailed with a specific exemplary example. It is assumed that the coarse classification result of the image derived by analyzing the image according to the coarse classification mode is “Flower” in the step 201. The step 202 inquires a classification relation table of Table 1 according to the coarse classification result “Flower”, and thus derives a fine classification model of “Flower variety” associated with the coarse classification result “Flower”. The step 203 inquires a level relation table of Table 2 according to the fine classification model “Flower variety”, and thus determines that one level information of the coarse classification model associated with the fine classification model “Flower variety” is “10”, i.e., the “10^{th}” level of the coarse classification model. Next, the step 204 retrieves one coarse feature descriptor corresponding to the level information “10” from the coarse classification model (data types presented by a general feature descriptor may be a floating-point number type, a character type or the like), and the coarse feature descriptor will be stored. The step 205 decides a fine classification result of “Rose” according to the fine classification model “Flower variety” and the at least one coarse feature descriptor.

Thereafter, the step 206 again inquires the classification relation table of Table 1 according to the fine classification result “Rose”, and thus derives a fine classification model of “Rose variety” associated with the fine classification result “Rose”. The step 207 determines that the number of all the fine classification models that have been derived has varied, and thus the aforesaid steps 203 to 207 are repeated.

Specifically, in step 203, one level information of “L” (i.e., a certain level in the low levels of the first to the third levels of the coarse classification model in the coarse classification module) of the coarse classification model associated with the fine classification model “Rose variety” is derived by inquiring the level relation table of Table 2 according to the fine classification model “Rose variety”. The step 204 retrieves at least one coarse feature descriptor corresponding to the level information “L” from the coarse classification model (as described above, data types presented by a general feature descriptor may be a floating-point number type, a character type or the like).

The step 205 decides a fine classification result of “Damascus rose” according to the fine classification model “Rose variety” and the coarse feature descriptor. The step 206 again inquires the classification relation table of Table 1 according to the fine classification result “Damascus rose” to derive the fine classification model associated with the fine classification result “Damascus rose”. The step 207 again determines whether the number of all the fine classification models that have been derived varies. If the determination result of the step 207 is yes, then the aforesaid steps 203 to 207 are repeated with each of the fine classification models that are newly derived (i.e., finer classification of the next level is continued), and the similar operations are performed continuously until no finer classification can be performed any more. On the contrary, if the determination result of the step 207 is no (i.e., the total number of the associated fine classification models “Flower type”, “Rose variety” that have been derived is 2 and does not vary or increase any more from the past to the present), then it means that this fine classification result “Damascus rose” is fine enough and no finer classification can be performed any more, and thus the coarse classification result “Flower” and the fine classification results “Rose” and “Damascus rose” are outputted at this point.

Moreover, in the aforesaid specific exemplary example, if a plurality of associated fine classification models are derived after inquiring the classification relation table of Table 1, then the subsequent steps 203 to 206 need to be performed for each of the fine classification models. Therefore, a plurality of fine classification results may be generated and finer classification is continuously performed on each of the fine classification results in the same manner as the above content, and this will not be further described herein.

In some implementations, the hierarchical image classification method may enable the at least one electronic computing device to execute the following steps (c) and (d) to newly add other preset classification models, and details of each of the steps are described in detail as follows.

Step (c): updating the classification relation table by recording a relation between the coarse classification model and a newly added fine classification model into the classification relation table, wherein the newly added fine classification model corresponds to one of the levels of the coarse model.

Step (d): updating the level relation table by recording the newly added fine classification model and a serial number of the level corresponding to the newly added fine classification model into the level relation table.

As can be known from the above descriptions, the hierarchical image classification method of the present invention first performs coarse classification on an image by using a coarse classification model, and inquiries which fine classification models associated with the coarse classification model are available at the next level according to the coarse classification result, and then further performs fine classification on the image by using the fine classification models derived. The hierarchical image classification method may continuously perform fine classification by repeating the aforesaid process until no finer classification can be performed any more, so accurate image classification rate can be provided. Moreover, by establishing correspondence relationships among classification models at different levels, the hierarchical image classification method can newly add other preset fine classification models at any time without the need of re-training all the classification models, thereby efficiently improving the accuracy of image classification.

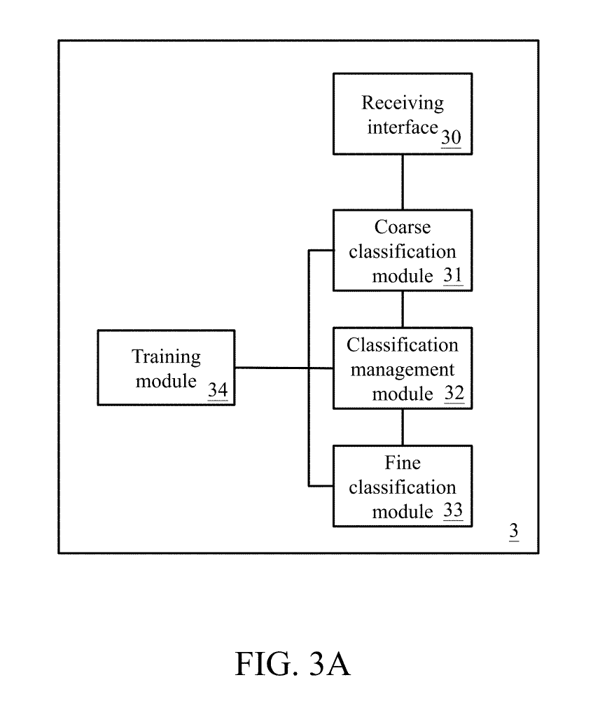

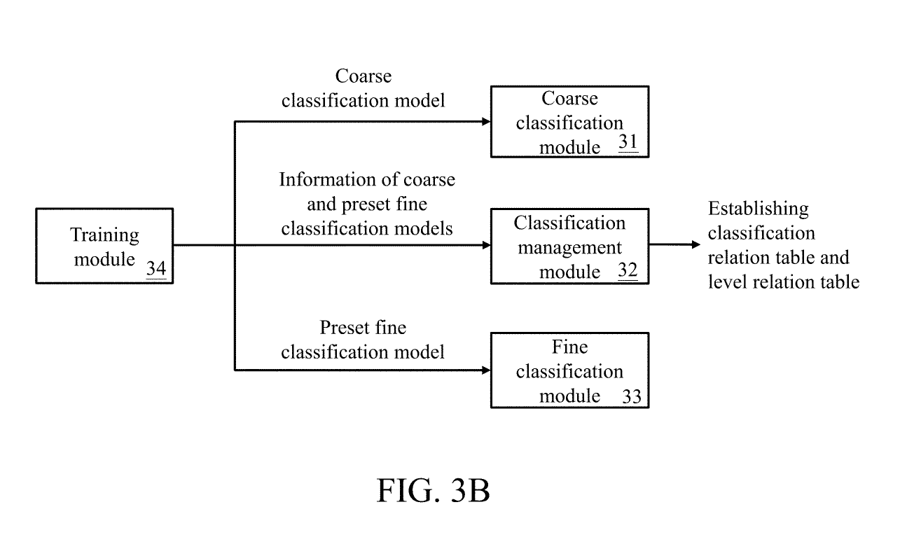

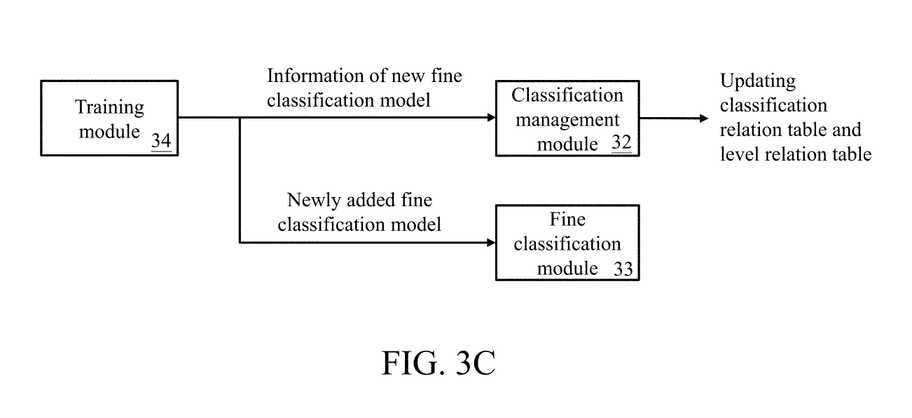

A second embodiment of the present invention is a hierarchical image classification system 3, and a block diagram thereof is depicted in FIG. 3A. The hierarchical image classification system 3 of the present invention comprises a receiving interface 30, a coarse classification module 31, a classification management module 32, a fine classification module 33 and a training module 34, wherein the receiving interface 30 is electrically connected to the coarse classification module 31, and the coarse classification module 31, the classification management module 32, the fine classification module 33 and the training module 34 are electrically connected to each other. In this embodiment, each of the coarse classification module 31, the classification management module 32, the fine classification module 33 and the training module 34 is a processor.

Each of the processors may be any of various central processing units (CPUs), graphics processing units (GPUs), microprocessors, control elements, other hardware elements capable of executing instructions, or other computing devices well known to those of ordinary skill in the art. Each of the coarse classification module 31, the classification management module 32, the fine classification module 33 and the training module 34 may comprise a database to store the coarse classification model, the fine classification model and the associated information and coarse feature descriptors thereof, and the database may be a memory, a universal serial bus (USB) disk, a hard disk, a compact disk (CD), a mobile disk, or any other storage medium or circuit with the same function and well known to those of ordinary skill in the art.

It shall be appreciated that, in some implementations, the coarse classification module 31, the classification management module 32, the fine classification module 33 and the training module 34 may operate on a same physical machine (e.g., a same processor). Moreover, in some implementations, the coarse classification module 31, the classification management module 32, the fine classification module 33 and the training module 34 may be executed on different processors with any combination, and exchange data through network transmission.

In this embodiment, the receiving interface 30 receives an image (e.g., from an image retrieving device) and inputs the image into the coarse classification module 31. The coarse classification module 31 receives the image, analyzes the image according to a coarse classification model to derive a coarse classification result, and inputs the coarse classification result to the classification management module 32.

The classification management module 32 receives the coarse classification result, and derives at least one fine classification model associated with the coarse classification result by inquiring a classification relation table according to the coarse classification result. Moreover, the classification management module 32 derives at least one level information of the coarse classification model associated with the at least one fine classification model respectively by inquiring a level relation table.

The classification management module 32 further notifies the fine classification module 33 that the at least one fine classification model is to be used for fine classification, and notifies the coarse classification module 31 that at least one coarse feature descriptor corresponding to the at least one level information needs to be retrieved from the coarse classification model. The coarse classification module 31 retrieves the at least one coarse feature descriptor corresponding to the at least one level information from the coarse classification model, and provides the at least one coarse feature descriptor to the fine classification module 33.

The fine classification module 33 decides at least one fine classification result according to the at least one fine classification model and the at least one coarse feature descriptor received, and inputs the at least one fine classification result into the classification management module 32. It shall be appreciated that, in some implementations, the fine classification module 33 stores the at least one coarse feature descriptor. In these implementations, if the level information that is the same as the previous level information is derived after the classification management module 32 inquires the level relation table, then it means that the coarse feature descriptor that is required is the same as the previous coarse feature descriptor. Therefore, the classification management module 32 may omit the aforesaid action of notifying the coarse classification module to retrieve the coarse feature descriptor.

Through the aforesaid operations, the hierarchical image classification system 3 of the second embodiment can determine the coarse classification result (i.e., to which coarse classification the image belongs) and the fine classification result (i.e., to which fine classification(s) the image belongs) of the image.

In some implementations, the classification management module 32 derives at least one fine classification model associated with each of the at least one fine classification result by inquiring the classification relation table again according to the at least one fine classification result inputted by the fine classification module 33. Similar to the aforesaid first embodiment, the classification management module 32, the coarse classification module 31 and the fine classification module 33 repeat the aforesaid operations to perform fine classification continuously. When the number of all the fine classification models that have been derived is unvaried, the classification management module 32 outputs the coarse classification result and the at least one fine classification result.

It shall be appreciated that, if the classification management module 32 obtains the level information that is the same as the previous level information after inquiring the level relation table again, then like the aforesaid first embodiment, the classification management module 32 does not need to notify the coarse classification module for the same coarse feature descriptor, and the classification management module 32 only needs to notify the fine classification module 33 that the at least one fine classification model is to be used for fine classification. The fine classification module 33 decides at least one fine classification result according to the at least one fine classification model and the at least one coarse feature descriptor that has been stored, and inputs the at least one fine classification result to the classification management module 32. The classification management module 32 derives at least one fine classification model associated with the at least one fine classification result by inquiring the classification relation table according to the at least one fine classification result being inputted, and continues to perform the next level of finer classification.

Schematic views illustrating the establishing and the updating of a classification relation table and a level relation table according to a second embodiment of the present invention are depicted in FIG. 3B to FIG. 3C. The training module 34 obtains the coarse classification model and a plurality of preset fine classification models by training with a deep learning method, inputs the coarse classification model and all the preset fine classification models being trained respectively into the coarse classification module 31 and the fine classification module 33, and inputs information of the coarse classification model and information of all the fine classification models into the classification management module 32. Therefore, the coarse classification module 31 comprises the coarse classification model, the fine classification module 33 comprises the preset fine classification models, and the aforesaid at least one fine classification model is included in the preset fine classification models. In some implementations, each of the coarse classification model and the preset fine classification models is a Deep Convolutional Neural Network (DCNN).

Any fine classification model comprised in the aforesaid fine classification module 33 is obtained by training with one of the following methods:

Method (a): training the coarse classification model with a fine-tune method or a transfer learning method by the training module 34; or

Method (b): training the coarse classification model with a coarse feature descriptor of a low level information (i.e., the so-called low level feature descriptor) of the coarse classification model by the training module 34.

Additionally, the classification management module 32 establishes the classification relation table according to relations among information of the coarse classification model of the coarse classification module 31, information of all the preset fine classification models of the fine classification module 33, and use of all the preset fine classification models. In other words, the classification relation table records relations between the coarse classification model and the preset fine classification models as well as relations among these preset fine classification models.

The classification management module 32 further establishes the level relation table according to all the preset fine classification models comprised in the fine classification module 33 and the level information of the coarse classification model associated with the preset fine classification models. For example, if the coarse classification model comprises a plurality of levels, then each of the preset fine classification models corresponds to one of the levels, and the level relation table records each of the preset fine classification models and a serial number of the level corresponding to the preset fine classification model.

In some implementations, contents of the coarse classification model of the coarse classification module 31, all the preset fine classification models of the fine classification module 33, the classification relation table and the level relation table may be updated at any time. For example (referring to FIG. 1B and FIG. 3C together), if a new fine classification model is to be added, then the training module 34 first trains the new fine classification model, inputs the new fine classification model that has been trained into the fine classification model 33, and inputs information of the new fine classification model into the classification management module 32. The classification management module 32 updates the classification relation table and the level relation table according to information inputted from the training module 34. For example, the classification management module 32 may update the classification relation table by recording a relation between the coarse classification model and a newly added fine classification model into the classification relation table. Moreover, the newly added fine classification model corresponds to one of the levels comprised in the coarse classification model, and the classification management module 32 can update the level relation table by recording the newly added fine classification model and a serial number of the level corresponding to the newly added fine classification model into the level relation table. Through the aforesaid operations, the adding of the new fine classification model is completed. Additionally, the training module 34 may also adjust, re-train or delete the existing fine classification models, and input relevant information into the classification management module 32 to update the classification relation table and the level relation table.

As can be known from the above descriptions, during the updating of the fine classification model in the present invention, only the fine classification model to be newly added needs to be trained, and the new fine classification model can be added simply by updating the classification relation table and the level relation table after the training operation is completed. The present invention does not need to re-train the coarse classification model and all the fine classification models.

It shall be appreciated that, since each of the coarse classification module 31, the classification management module 32, the fine classification module 33 and the training module 34 is a processor in this embodiment, signal and data transmission exist among these modules. However, if some or all of the coarse classification module 31, the classification management module 32, the fine classification module 33 and the training module 34 are integrated into a same processor in other embodiments, then some or all of the aforesaid signal and data transmission may be omitted.

In addition to the aforesaid contents, the second embodiment can also execute all the operations and steps set forth in the first embodiment, have the same functions and deliver the same technical effects as the first embodiment. How the second embodiment executes these operations and steps, has the same functions and delivers the same technical effects as the first embodiment will be readily appreciated by those of ordinary skill in the art based on the explanation of the first embodiment, and thus will not be further described herein.

As can be known from the aforesaid embodiments, the hierarchical image classification method and system of the present invention first performs coarse classification on an image by using a coarse classification model, and inquiries which fine classification models associated with the coarse classification model are available at the next level according to the coarse classification result, and then further performs fine classification on the image by using the fine classification model derived. The hierarchical image classification method and system of the present invention may continuously perform fine classification by repeating the aforesaid process until no finer classification can be performed any more, so accurate image classification rate can be provided. Moreover, the hierarchical image classification method and system of the present invention can update relevant information of the fine classification models (i.e., add, delete or adjust the fine classification models) at any time without the need of re-training all the classification models (i.e., the coarse classification model and all the preset fine classification models), thereby saving the training time, adjusting or updating the fine classification models adaptively, and efficiently improving the accuracy of image classification.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A hierarchical image classification method adapted for at least one electronic computing device, the hierarchical image classification method comprising:
(a) deriving a coarse classification result of an image by analyzing the image according to a coarse classification model;
(b) deriving at least one fine classification model associated with the coarse classification result by inquiring a classification relation table according to the coarse classification result;
(c) deriving at least one level information of the coarse classification model associated with the at least one fine classification model respectively by inquiring a level relation table according to the at least one fine classification model;
(d) retrieving at least one coarse feature descriptor corresponding to the at least one level information respectively from the coarse classification model; and
(e) deciding at least one fine classification result according to the at least one fine classification model and the at least one coarse feature descriptor.

2. The hierarchical image classification method of claim 1, further comprising:
(f) deriving at least one fine classification model associated with each of the at least one fine classification result by inquiring the classification relation table according to the fine classification result; and
(g) repeating the steps (c) to (f) until the number of the at least one fine classification model derived is unvaried, and then outputting the coarse classification result and the at least one fine classification result.

3. The hierarchical image classification method of claim 2, further comprising storing the at least one coarse feature descriptor.

4. The hierarchical image classification method of claim 3, wherein in the process of repeating the steps (c) to (f), the step (d) will be omitted if the at least one level information derived is the same as the previous level information.

5. The hierarchical image classification method of claim 1, wherein the at least one electronic computing device comprises the coarse classification model and a plurality of preset fine classification models, the preset fine classification models include the at least one fine classification model, and the coarse classification model and the preset fine classification models are obtained by training with a deep learning method individually.

6. The hierarchical image classification method of claim 5, wherein each of the coarse classification model and the preset fine classification models is a Deep Convolutional Neural Network (DCNN).

7. The hierarchical image classification method of claim 5, wherein the classification relation table records a relation between the coarse classification model and the preset fine classification models, the coarse classification model comprises a plurality of levels, each of the preset fine classification models corresponds to one of the levels, and the level relation table records each of the preset fine classification models and a serial number of the level corresponding to the preset fine classification model.

8. The hierarchical image classification method of claim 7, further comprising:
updating the classification relation table by recording a relation between the coarse classification model and a newly added fine classification model into the classification relation table, wherein the newly added fine classification model corresponds to one of the levels; and
updating the level relation table by recording the newly added fine classification model and a serial number of the level corresponding to the newly added fine classification model into the level relation table.

9. The hierarchical image classification method of claim 5, further comprising:
obtaining the preset fine classification models by training the coarse classification model with one of or a combination of a fine-tune method and a transfer learning method.

10. The hierarchical image classification method of claim 5, further comprising:
obtaining the preset fine classification models by training the coarse classification model with a coarse feature descriptor of a low level information of the coarse classification model.

11. A hierarchical image classification system, comprising:
a receiving interface, being configured to receive an image; and
at least one processor, being electrically connected to the receiving interface and being configured to execute a coarse classification module, a classification management module, and a fine classification module;
wherein (a) the coarse classification module derives a coarse classification result of the image by analyzing the image according to a coarse classification model; (b) the classification management module derives at least one fine classification model associated with the coarse classification result by inquiring a classification relation table according to the coarse classification result; (c) the classification management module derives at least one level information of the coarse classification model associated with the at least one fine classification model respectively by inquiring a level relation table according to the at least one fine classification model; (d) the coarse classification module retrieves at least one coarse feature descriptor corresponding to the at least one level information respectively from the coarse classification model; and (e) the fine classification module decides at least one fine classification result according to the at least one fine classification model and the at least one coarse feature descriptor.

12. The hierarchical image classification system of claim 11, wherein (f) the classification management module further derives at least one fine classification model associated with each of the at least one fine classification result by inquiring the classification relation table according to the fine classification result, the at least one processor repeats the aforesaid operations (c) to (f) until the number of the at least one fine classification model derived is unvaried, and the classification management module outputs the coarse classification result and the at least one fine classification result.

13. The hierarchical image classification system of claim 11, wherein the fine classification module further stores the at least one coarse feature descriptor.

14. The hierarchical image classification system of claim 13, wherein in the process of repeating the aforesaid operations (c) to (f) by the at least one processor, the step (d) will be omitted if the at least one level information derived is the same as the previous level information.

15. The hierarchical image classification system of claim 11, wherein the at least one processor further executes a training module, the coarse classification module comprises the coarse classification model, the fine classification module comprises a plurality of preset fine classification models, and the training module obtains the coarse classification model and the preset fine classification models by training with a deep learning method individually.

16. The hierarchical image classification system of claim 15, wherein each of the coarse classification model and the preset fine classification models is a Deep Convolutional Neural Network (DCNN).

17. The hierarchical image classification system of claim 15, wherein the classification relation table records a relation between the coarse classification model and the preset fine classification models, the coarse classification model comprises a plurality of levels, each of the preset fine classification models corresponds to one of the levels, and the level relation table records each of the preset fine classification models and a serial number of the level corresponding to the preset fine classification model.

18. The hierarchical image classification system of claim 17, wherein the classification management module updates the classification relation table by recording a relation between the coarse classification model and a newly added fine classification model into the classification relation table, with the newly added fine classification model corresponding to one of the levels, and updates the level relation table by recording the newly added fine classification model and a serial number of the level corresponding to the newly added fine classification model into the level relation table.

19. The hierarchical image classification system of claim 15, wherein the training module further obtains the preset fine classification models by training the coarse classification model with one of or a combination of a fine-tune method and a transfer learning method.

20. The hierarchical image classification system of claim 15, wherein the training module further obtains the preset fine classification models by training the coarse classification model with a coarse feature descriptor of a low level information of the coarse classification model.
